(19) United States
(12) Patent Application Publication
(10) Pub. No.: US 2014/0225752 A1
(43) Pub. Date: Aug. 14, 2014

(54) PREDICTIVE TRAFFIC LIGHT FOR AN INTERSECTION FOR PREVENTING ACCIDENTS

(71) Applicant: Eui Ho Lee, Incheon (KR)

(72) Inventor: Eui Ho Lee, Incheon (KR)

(21) Appl. No.: 14/346,758

(22) PCT Filed: Sep. 14, 2012
(86) PCT No.: PCT/KR2012/007354

§ 371 Date: Mar. 24, 2014

(30) Foreign Application Priority Data
Sep. 23, 2011 (KR) 10-2011-0096235

(51) Int. Cl. G08G 1/095; F21K 99/00; G08G 1/096

(52) U.S. Cl. CPC G08G 1/095; G08G 1/096; F21K 9/50
USPC 340/929

(57) ABSTRACT

The present invention relates to a predictive intersection traffic light that indicates when a green light changes to other light, and can stop a driver from accelerating and tailgating when entering the intersection. The predictive traffic light of two or more colors, which controls a green light and indicates a remaining operation time of the green light, includes a traffic light main body displaying a red light that is a stop signal, a yellow light that is a preparatory intermediate signal, a turn signal light, and a green light that is a proceed light. Here, the green light of the main body comprises Light Emitting Diodes (LEDs) arranged in a plurality of circular rows at the outer side of the green light and an indicating plate that is surrounded by the arranged LEDs and indicates only the number for countdown time until the green light turns off such that a driver knows the remaining operation time of the green light that is a proceed signal.

### CROSS-REFERENCE TO RELATED APPLICATION

This application claims the benefit of Korean Patent Application No.10-2011-0096235, filed on Sep. 23, 2011 in the Korean Intellectual Property Office, the disclosure of which is incorporated herein by reference.

### TECHNICAL FIELD

The present invention disclosed herein relates to a predictive traffic light for preventing accidents. More particularly, it relates to a predictive intersection traffic light that indicates when a green light changes to other light, and can stop a driver from accelerating and tailgating when entering the intersection.

### BACKGROUND ART

Generally, a vehicle traffic light is installed along streets for smooth traffic flow.

Typical traffic lights are configured to perform only a flash-on/off function using filament-type incandescent lamps.

However, there are limitations in that incandescent lamps consume much electricity and thus cost high in maintenance and in that the bulbs need to be frequently replaced because filament in the bulbs lasts for short time.

Accordingly, the use of Light Emitting Diode (LED) traffic lights is a recent trend intended to overcome the limitation. An LED traffic light is a high energy efficient product whose electric consumption is less than 10 Watt, about one tenth of that of incandescent traffic light, thus with about 80% to about 90% energy-save effect for the same luminance.

LED traffic light demand is recently rising for the advantages of less consumption of electricity than typical traffic light that uses filament bulbs, and higher luminance, and longer duration and also for the advantage that LEDs can still be used with a few damaged LEDs.

As described above, efficiency of the lamps improves, but traffic accidents at an intersection are increasing in number. Causes of the accidents are rear-ending and traffic light violation.

Tailgating during rush hour also resulted from unpredictability of traffic light changing time.

A typical sequential signaling system involves limitations in that a driver, unable to see what moment traffic light changes, cannot pass through an intersection or interrupts parts of the intersection as a proceed signal abruptly turns into a stop signal, causing traffic congestion and particularly rear-ending accidents.

### DISCLOSURE

### Technical Problem

The present invention provides a predictive intersection traffic light that allows a driver to know how longer a proceed light is left on and thus stop the driver from entering the intersection against the odds such that accidents resulting from rear-ending, traffic light violation and tailgating are prevented.

### Technical Solution

Embodiments of the present invention provide predictive intersection traffic lights that enable predictable proceeding by indicating the time until the proceed signal light changes with a countdown time displayed at the center of the green traffic light.

In other embodiments of the present invention, predictive traffic lights for preventing accidents include a display window installed over or under the proceed light and flashing countdown.

### Advantageous effects

A predictive intersection traffic light according to an embodiment of the present invention has the effect of enabling a driver to predict the change of light and preventing a driver from accelerating into an accident without recognizing the change of a proceed signal.

### BRIEF DESCRIPTION OF DRAWINGS

FIG. 1 is a view illustrating a predictive intersection traffic light for preventing accidents according to an embodiment of the present invention.

FIG. 2 is a perspective view illustrating a predictive intersection traffic light according to an embodiment of the present invention.

FIG. 3 is a view illustrating a traffic light in operation showing sequential numerical countdown according to an embodiment of the present invention.

FIG. 4, is a view illustrating a display unit disposed over a proceed signal light so as to be visible even from a distant place according to another embodiment of the present invention.

FIG. 5 is a view illustrating a separate traffic light disposed under a main body of a green light according to still another embodiment of the present invention.

### BEST MODES FOR CARRYING OUT THE PRESENT INVENTION

Hereinafter, exemplary embodiments of the predictive intersection traffic light for preventing accidents will be described in detail with the reference to the accompanying drawings.

According to embodiments of the present invention, the intersection vehicle traffic lights of the present invention may be classified into blinking light, 2-color to 4-color light according to the location. Traffic lights may include a red light that is a stop signal, a yellow light that is a preparatory and intermediate signal, a green light that is a proceed signal, and a turn signal light. A sequential operation system may be maintained such that a certain time after one traffic light turns on, the one traffic light turns off and simultaneously another traffic light turns on according to a predetermined order.

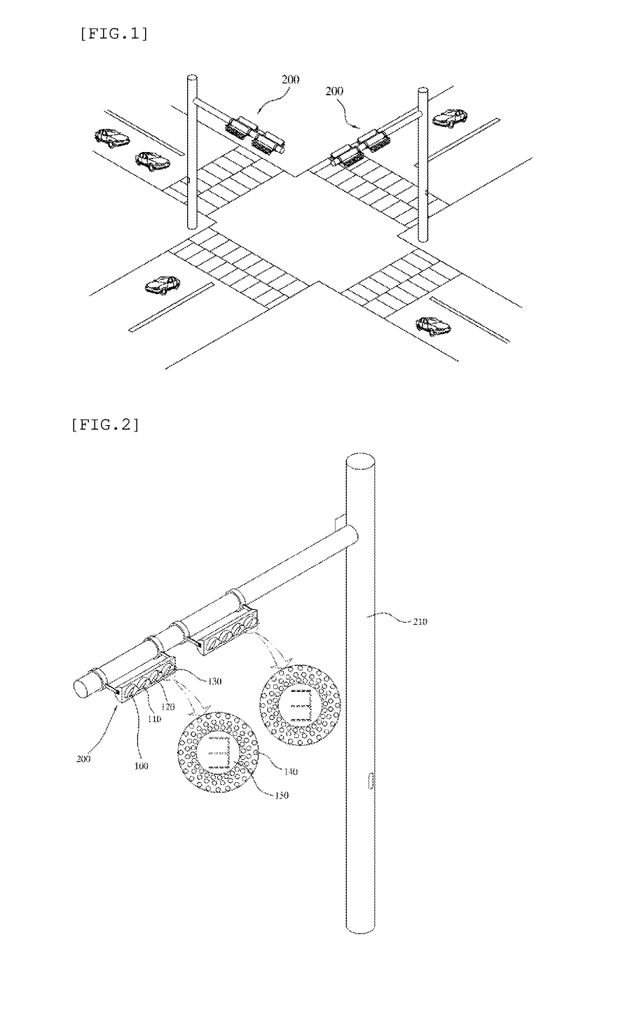

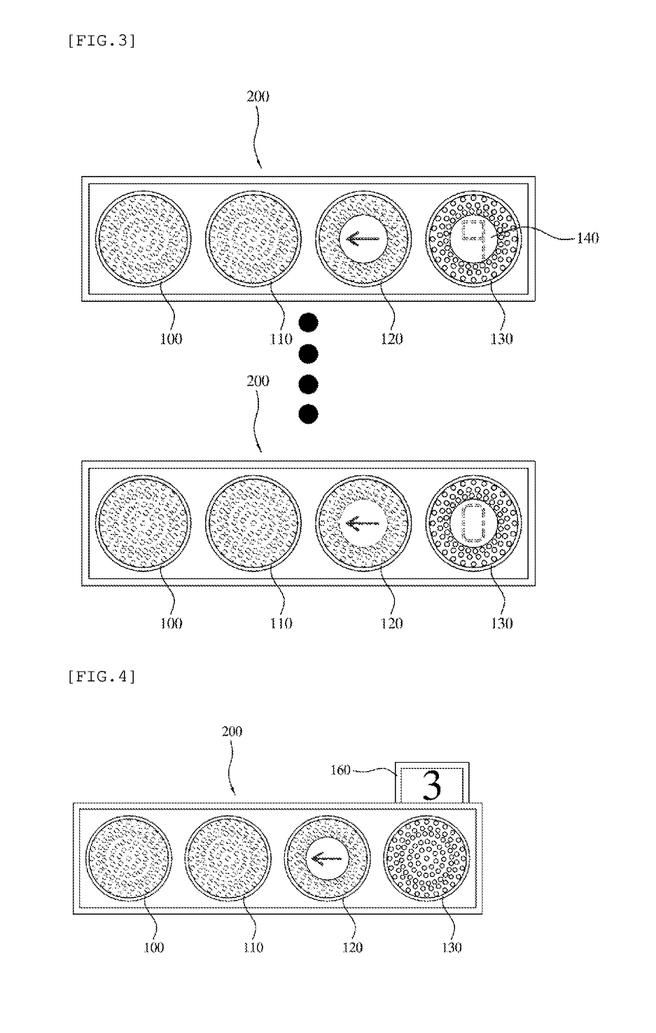

As shown in FIGS. 1 to 4, the predictive traffic lights of two or more colors may include a main body including a red light that is a stop signal, a yellow light that is a preparatory intermediate signal, a green light that is a proceed signal, and a turn signal light.

The green light 130 in the main body 200 of the traffic lights may include an arrangement of plural concentric circles of LEDs 140 outside and indicator plate 150 in the center indicating the time left until the green light turns off, thereby enabling a driver to know the time left.

The traffic light main body 200 may include each traffic light 100, 110, 120 and 130, and may protect the internal components from external impact while its outer case is firmly attached to a street pole 210.

The main body 200 of traffic lights as described above may be installed such that a driver can see the lights. The driver may pass through while seeing the traffic light. However, there may be difficulty in determining when the green light turns off after the green light turns on. Also, a driver in a vehicle running at a distant place cannot know whether or not to pass through now or how much time is left.

Accordingly, the embodiments of the present invention may provide a predictive traffic light that indicates how much time is left on the proceed light such that a driver can determine whether to proceed or not. The green light 130 shown in FIG. 3 may include LEDs 140 arranged in a plurality of circular rows and an indicator part 150 disposed in the center thereof and showing digits. The digits may show from 20 to 0 or 10 to 0. Total proceed signaling time can also be shown in digital countdown if necessary.

In another embodiment of the present invention, since the digits are difficult to display on the proceed light and to see from a distance place, a member may be separately installed over the main body of the proceed light or a display unit may be formed under the main body such that a driver can see the member or the display unit from a distant place. That is, as shown in FIG. 4, a display plate 160 may be installed over or under the green light 130 disposed in the main body 200 of the traffic light to show a countdown time when the green light turns off such that a driver can know the remaining time of the traveling direction and thus prevent a vehicle from indiscreetly entering the intersection. Thus, accidents can be prevented beforehand.

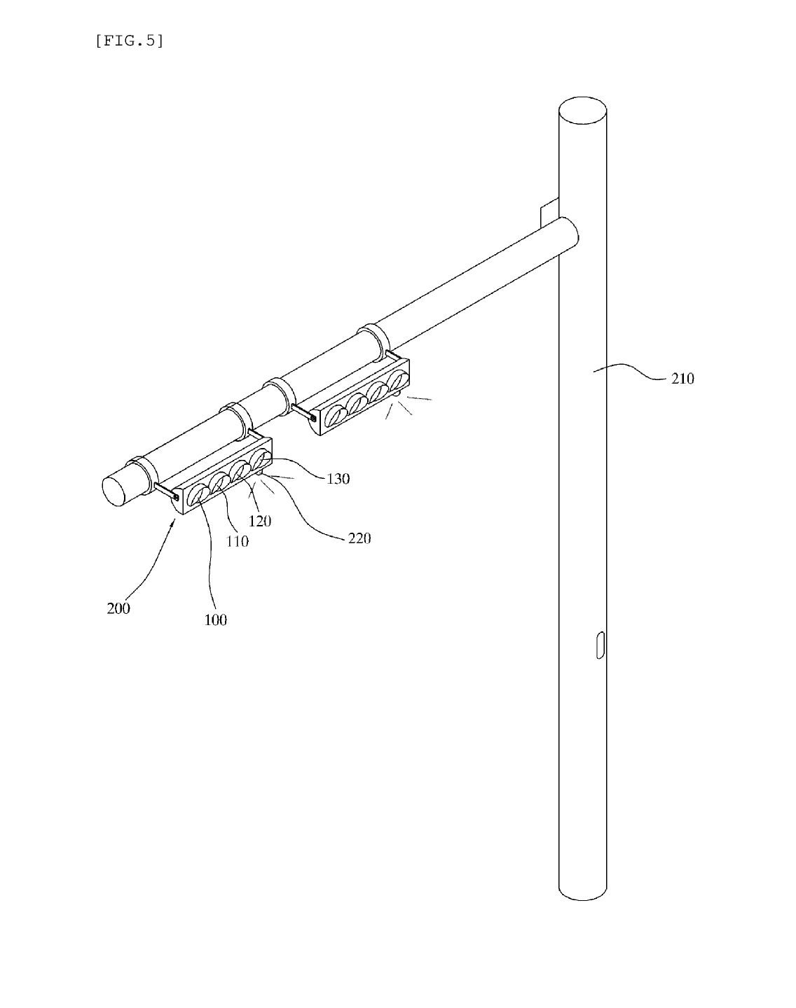

In still another embodiment of the present invention, as shown in FIG. 5, a green light 220 may be separately added to the undersurface of the proceed light or a through hole may be formed in the undersurface of the proceed light such that a driver can know that the signal changes when a vehicle stops at a place where the traffic lights are installed.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A predictive traffic light of two or more colors, which controls a green light and indicates a remaining operation time of the green light, comprising: a traffic light main body displaying a red light that is a stop signal, a yellow light that is a preparatory intermediate signal, a turn signal light, and a green light that is a proceed light,
wherein the green light of the main body comprises Light Emitting Diodes (LEDs) arranged in a plurality of circular rows at the outer side of the green light and an indicating plate that is surrounded by the arranged LEDs and indicates only the number for countdown time until the green light turns off such that a driver knows the remaining operation time of the green light that is a proceed signal.

2. The predictive traffic light of claim 1, wherein the green light comprises a display panel disposed thereover or thereunder so as to display a countdown time by number until the green light turns off or to another light.

3. The predictive traffic light of claim 1, wherein the main body of the traffic light has a through hole vertically formed in an undersurface thereof such that light of an auxiliary green light or the green light is easily viewed by a driver under the traffic lights.
